(19) United States
(12) Patent Application Publication
(10) Pub. No.: US 2002/0109823 A1
(43) Pub. Date: Aug. 15, 2002

(54) Wafer stage assembly

(75) Inventors: Michael Binnard, Belmont, CA (US); Andrew J. Hazelton, San Carlos, CA (US); Kazuya Ono, San Carlos, CA (US); Martin E. Lee, Saratoga, CA (US); W. Thomas Novak, Hillsborough, CA (US)

Correspondence Address: FINNEGAN, HENDERSON, FARABOW, GARRETT &, DUNNER LLP, 1300 I STREET, NW, WASHINGTON, DC, 20005, US

(73) Assignee: Nikon Corporation.

(21) Appl. No.: 09/779,522

(22) Filed: Feb. 9, 2001

(51) Int. Cl. B32B 3/00; B32B 27/14; G03H 3/00

(52) U.S. Cl. 355/53; 428/195

(57) ABSTRACT

A wafer stage assembly is provided to be used in combination with a projection lens assembly, such as in a semiconductor wafer manufacturing process. The wafer stage assembly includes a wafer table supported and positioned by a wafer stage and a wafer stage base for carrying a semiconductor wafer. The wafer stage assembly also includes a plurality of sets of sensors to determine a position and a rotation of the wafer table in six degrees of freedom relative to the projection lens assembly. A first set of sensors determines a position and a rotation of the wafer table relative to the projection lens assembly in at least one of the six degrees of freedom, while a second set of sensors determines a position and a rotation of the wafer table relative to the wafer stage base in the remaining of the six degrees of freedom.

### BACKGROUND OF THE INVENTION

1. Field of the Invention

This invention relates to a wafer stage assembly, a wafer table servo control system and to a method for operating the same in a photolithography process to manufacture semiconductor wafers. More particularly, this invention relates to the wafer stage assembly, wafer table servo control system and method of operation to increase focusing properties of the photolithography system.

2. Description of the Related Art

In manufacturing integrated circuits using photolithography, an energy beam, such as light, is transmitted through non-opaque portions of a pattern on a reticle, or photomask, through a projection exposure apparatus, and onto a wafer of specially-coated silicon or other semiconductor material. The uncovered portions of the coating that are exposed to light are cured. The uncured coating is then removed by an acid bath. Thus, the layer of uncovered silicon is altered to produce one layer of the multi-layered integrated circuit. Conventional systems use visible and ultraviolet light for this process. Recently, however, visible and ultraviolet light have been replaced with electron, x-ray, and laser beams, which permit smaller and more intricate patterns.

As the miniaturization of a circuit pattern progresses, the focus depth of the projection exposure apparatus becomes very small, making it difficult to align accurately the overlay of circuit patterns of the multi-layered integrated circuit. As a result, a primary consideration for an overall design of the photolithography system includes building components of the system that achieve precision by maintaining small tolerances. Any vibration, distortion, or misalignment caused by internal, external or environmental disturbances must be kept at minimum. When these disturbances affect an individual part, the focusing properties of the photolithography system are collectively altered.

FIG. 1 illustrates a conventional exposure apparatus 21 having a projection lens system 78 to manufacture semiconductor wafers 68. Exposure apparatus 21 has a unibody structure because a universal apparatus frame 72 supports the system as a whole. A wafer stage 66 positions a semiconductor wafer 68 as wafer stage 66 is being accelerated by a force (not shown) generated in response to a wafer manufacturing control system (not shown). The wafer manufacturing control system is the central computerized control system executing the wafer manufacturing process.

In operation, exposure apparatus 21 transfers a pattern of an integrated circuit from reticle 80 onto semiconductor wafer 68. Exposure apparatus 21 is mounted to a base 82, i.e., the ground or via a vibration isolation system to isolate apparatus frame 72 from internal, external, and environmental disturbances. Apparatus frame 72 is rigid and supports the components of exposure apparatus 21, including wafer stage assembly 90 (shown in FIG. 2), lens assembly 78, reticle stage 76, and illumination system 74.

Illumination system 74 includes an illumination source 84 to emit a beam of light energy. Illumination system 74 also includes an illumination optical assembly 86 to guide the beam of light energy from illumination source 84 to lens assembly 78. The beam illuminates selectively different portions of reticle 80 and exposes wafer 68.

Lens assembly 78 projects and/or focuses the light passing through reticle 80 to wafer 68. Lens assembly 78 may magnify or reduce the image illuminated on reticle 80. Lens assembly 78 may also be a 1× magnification system.

Reticle stage 76 holds and positions reticle 80 relative to lens assembly 78 and wafer 68. Similarly, wafer stage 66 holds and positions wafer 68 with respect to the projected image of the illuminated portions of reticle 80. Reticle stage 76 and wafer stage 66 may be positioned by a plurality of motors 10.

Different types of photolithographic devices, including a scanning type and a step-and-repeat type, have been used. In the scanning type photolithography system, illumination system 74 exposes the pattern from reticle 80 onto wafer 68 with reticle 80 and wafer 68 moving synchronously. Reticle stage 76 moves reticle 80 on a plane which is generally perpendicular to an optical axis of lens assembly 78, while wafer stage 66 moves wafer 68 on another plane generally perpendicular to the optical axis of lens assembly 78. Scanning of reticle 80 and wafer 68 occurs while reticle 80 and wafer 68 are moving synchronously.

Alternatively, in the step-and-repeat type photolithography system, illumination system 74 exposes reticle 80 while reticle 80 and wafer 68 are stationary. Wafer 68 is in a constant position relative to reticle 80 and lens assembly 78 during the exposure of an individual field. Subsequently, between consecutive exposure steps, wafer 68 is consecutively moved by wafer stage 66 perpendicular to the optical axis of lens assembly 78 so that the next field of semiconductor wafer 68 is brought into position relative to lens assembly 78 and reticle 80 for exposure. Following this process, the images on reticle 80 are sequentially exposed onto the fields of wafer 68 so that the next field of semiconductor wafer 68 is brought into position relative to lens assembly 78 and reticle 80.

Regardless of the type of photolithography system is used, to focus accurately the image transferred from reticle 80 onto wafer 68, exposure apparatus 21 must align an exposure point (not shown) on wafer 68 with a focal point (not shown) of projection lens system 78. An auto-focus and auto-leveling (AF/AL) sensor, diagrammatically shown in FIG. 2 as arrow 114, can determine the position of focal point relative to the exposure point. However, using AF/AL sensor 114 alone does not suffice because of the limitations of AF/AL sensors. The limitations are, first, it operates over a small detection range, i.e., only when wafer 68 is placed directly under projection lens assembly 78; second, it requires substantial signal process causing a delay in generating an output; and finally, it is easily influenced by variations in the wafer topography, thus reducing its accuracy.

Therefore, there is a need for an improved sensor, either to replace or to be used in combination with the AF/AL sensor, which can determine the position and rotation of the exposure point relative to the focal point.

In the unibody structure as shown in FIG. 1, wafer stage base 102 is rigidly connected to projection lens assembly 78 providing a constant position of wafer stage base 102 relative to projection lens assembly 78. A fixed position of wafer stage base 102 provides a reference point for measuring its position relative to projection lens assembly 78.

Recently, a photolithography system has been proposed which has a multi-body structure in which wafer stage assembly 90, such as shown in FIG. 2, is supported by a first vibration isolation system 122, while projection lens system 78 is supported by a second vibration isolation system 124, separate from the first vibration isolation system 122. The position of wafer stage base 102 relative to projection lens system 78 varies as the first and second vibration isolation systems 122,124, respectively, move relative to each other. Therefore, in the multi-body structure, wafer stage base 102 is no longer fixed in position relative to projection lens assembly 78.

A conventional wafer stage assembly 90 may be used in a unibody or a multi-body photolithography system. Wafer stage assembly 90 includes a wafer table 104, a wafer stage 66, and a wafer stage base 102. Wafer stage base 102 supports wafer stage 66. Wafer stage assembly 90 use a plurality of interferometers 110 and encoders 112 in combination with AF/AL sensor, diagrammatically referred to as reference number 114, to determine a position and a rotation of wafer table 104 relative to projection lens assembly 78.

Interferometers 110 measure the position and rotation of wafer table 104 relative to projection lens assembly 78, while encoders 112 measure the position and rotation of wafer table 104 relative to wafer stage 66.

Wafer stage 66 rides on wafer stage base 102 via an air bearing 126, which is a thin layer of pressurized air allowing wafer stage 66 to move along the x and y axes with essentially zero friction. In practice, air bearing 126 acts like a stiff spring, so the vertical distance between wafer stage 66 and wafer stage base 102, commonly referred to as flying height of wafer stage 66, is basically a constant. Therefore, the position and rotation of wafer table 104 relative to wafer stage base 102 can be determined. However, encoders 112 do not account for the varying flying height of wafer stage 66, relative motion between first and second vibration isolation systems 122, 124, respectively, nor other structural deformation in exposure apparatus 21 that causes a change in the vertical position between wafer stage base 102 and projection lens system 78.

In light of the foregoing, there is a need for a wafer stage assembly having an improved way of measuring the position and rotation of the wafer table relative to the projection lens assembly. There is also a need for an improved method for measuring a position and rotation of the wafer table with a more steady referencing surface than the wafer stage. In addition, since the AF/AL sensor operates with several limitations, there is a need for an alternate or a supplemental sensor that operates on a higher bandwidth and works even when the wafer is not positioned directly under the projection lens assembly.

### SUMMARY OF THE INVENTION

The advantages and purposes of the invention will be set forth in part in the description which follows, and in part will be obvious from the description, or may be learned by practice of the invention. The advantages and purposes of the invention will be realized and attained by the elements and combinations particularly pointed out in the appended claims.

To attain the advantages and consistent with the principles of the invention, as embodied and broadly described herein, in a first aspect of the invention, a wafer stage assembly is provided for use in combination with a projection lens assembly in a semiconductor wafer manufacturing process. The wafer stage assembly comprises a wafer table supported and positioned by a wafer stage and a wafer stage base for carrying at least one semiconductor wafer, and at least one sensor system that determines position and rotation of the wafer table in six degrees of freedom relative to the projection lens assembly, at least a part of the sensor system being connected to the wafer table.

In a second aspect of the present invention, an exposure apparatus is provided to form a pattern on a wafer by utilizing a projection lens assembly. The exposure apparatus comprises a wafer stage assembly having a wafer table that carries the wafer, and a wafer stage that positions the wafer table on a wafer stage base. The exposure apparatus also comprises a first sensor system that detects at least one of position and rotation of the wafer table relative to the projection lens assembly, and a second sensor system that detects at least one of position and rotation of the wafer table relative to the stage base.

A third aspect of the present invention is the provision of a method for making a wafer stage assembly for use in combination with a projection lens assembly in a semiconductor wafer manufacturing process. The method comprises the steps of providing a wafer table supported and positioned by a wafer stage and a wafer stage base for carrying a semiconductor wafer, and connecting a part of a first sensor system to the wafer table so that the first sensor system determines position and rotation of the wafer table relative to the projection lens assembly. The method also comprises the step of connecting a part of a second sensor system to the wafer table so that the second sensor system determines position and rotation of the wafer table relative to the wafer stage base.

A fourth aspect of the present invention is to provide a method for determining a position of a semiconductor wafer table in a semiconductor wafer manufacturing process. The method comprises the step of supporting and positioning a semiconductor wafer on a wafer stage assembly relative to a projection lens system, the wafer stage assembly having a wafer table, a wafer stage, and a wafer stage base. The method also comprises the step of measuring position and rotation of the wafer table in six degrees of freedom relative to the projection lens assembly.

A fifth aspect of the present invention is to provide a method for determining a position on a surface of a semiconductor wafer relative to a projection lens system, the wafer being supported by a wafer table and positioned by a wafer stage and a wafer stage base. The method comprises the steps of determining position and rotation of the wafer table relative to a projection lens system, and determining position and rotation of the wafer table relative to the wafer stage base.

It is to be understood that both the foregoing general description and the following detailed description are exemplary and explanatory only and are not restrictive of the invention as claimed. Additional advantages will be set forth in the description which follows, and in part will be understood from the description, or may be learned by practice of the invention. The advantages and purposes may be obtained by means of the combinations set forth in the attached claims.

### BRIEF DESCRIPTION OF THE DRAWINGS

The accompanying drawings, which are incorporated in and constitute a part of this specification, illustrate several embodiments of the invention and, together with the description, serve to explain the principles of the invention. In the drawings,

FIG. 1 is an elevation view of a conventional exposure apparatus in a unibody photolithography structure;

FIG. 2 is an elevation view of a conventional wafer stage assembly of an exposure apparatus in a multi-body photolithography structure;

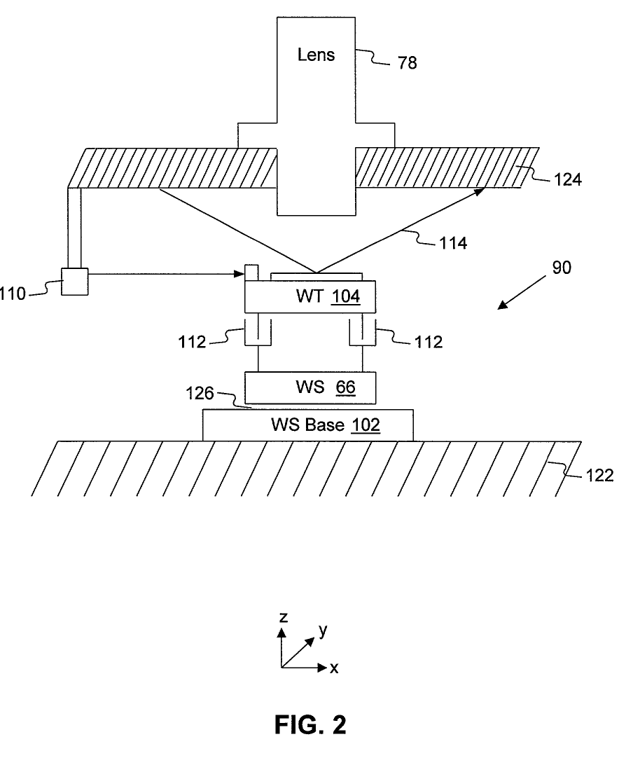

FIG. 3 is an elevation view of a first embodiment of a wafer stage assembly consistent with the principles of the present invention;

FIG. 4 is a block diagram of a wafer table control system consistent with the principles of the present invention;

FIG. 5 is an elevation view of a second embodiment of the wafer stage assembly consistent with the principles of the present invention;

FIG. 6 is an elevation view of a third embodiment of the wafer stage assembly consistent with the principles of the present invention;

FIG. 7 is an elevation view of detailing the second sensor of the third embodiment of the wafer stage assembly consistent with the principles of the present invention;

FIG. 8 is a flow chart outlining a process for manufacturing an apparatus consistent with the principles of the present invention; and

FIG. 9 is a flow chart outlining the manufacturing processing of FIG. 8 in more detail.

### DESCRIPTION OF THE INVENTION

Reference will now be made in detail to several embodiments of the wafer stage assembly, exposure apparatus, and method consistent with the principles of the present invention, examples of which are illustrated in the accompanying drawings. The invention will be further clarified by the following examples, which are intended to be exemplary of the invention.

A wafer stage assembly and method of operating the same, consistent with the principles of this invention, are useful to determine a position of a wafer table relative to a projection lens assembly, so that the wafer table can be positioned to align an exposure point on a semiconductor wafer with a focal point of the projection lens assembly to accurately focus an image transferred from a reticle onto the semiconductor wafer. This invention is not limited to any particular application, rather, the assembly and method disclosed herein could be used in any system configured to embody similar elements. Although the principles of the present invention are useful for a photolithography device having a multi-body structure, the same principles may also be applied in a photolithography device having a unibody structure.

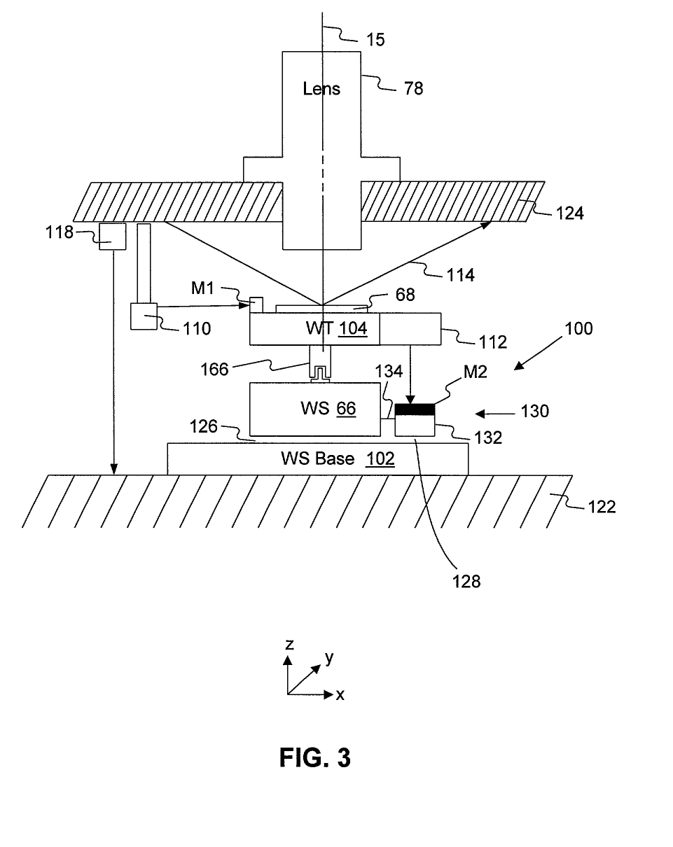

Similar to wafer stage assembly 90 described in the Description of the Related Art, a wafer stage assembly 100, consistent with the principles of the present invention, and as diagrammatically illustrated in FIG. 3, includes a wafer table 104 for supporting a semiconductor wafer 68 and a wafer stage 66 for positioning wafer 68 as wafer stage 66 is accelerated by a force (not shown) generated in response to a wafer manufacturing control system (not shown). Wafer stage assembly 100 also includes a wafer stage base 102 for supporting wafer stage 66. A bearing 126 separates wafer stage 66 from wafer stage base 102.

Wafer stage assembly 100 is used in a multi-body photolithography system whereby wafer stage assembly 100 is supported by a first vibration isolation system 122, while projection lens assembly 78 is supported by a second vibration isolation system 124, separate from first vibration isolation system 122.

A set of flexures (not shown) may be provided to connect wafer table 104 to wafer stage 66 for supporting wafer table 104. If viewed downward along the z axis, wafer stage 66 and wafer table 104 may have a circular configuration, substantially concentrically arranged, and the set of flexures being distributed around the concentric configuration connecting wafer table 104 to wafer stage 66. The flexures are capable of resisting planar motion between wafer table 104 and wafer stage 66 along the x and y axes, while allowing vertical motion along the z axis. The flexures may be made of steel.

Consistent with the principles of the present invention, wafer stage assembly 100 includes a first sensor 110 to determine a position and a rotation of wafer table 104 relative to projection lens assembly 78, and a second sensor 112 to determine a position and a rotation of wafer table 104 relative to wafer stage base 102.

First sensor 110 may be a first plurality of interferometers, such as, a first i interferometer (not shown) to measure a distance of wafer table 104 relative to projection lens assembly 78 along the x axis (dₓ), a second interferometer (not shown) to measure a distance of wafer table 104 relative to projection lens assembly 78 along the y axis (d_{y}), and a third interferometer (not shown) to measure a rotation of wafer table 104 relative to projection lens assembly 78 around the z axis (θ_{z}). The z axis is parallel to an optical axis 15 of projection lens assembly 78, and the x and y axes are orthogonal to the z axis.

First sensor 110 may be directly attached to projection lens assembly 78, or indirectly attached via second vibration isolation system 124 supporting projection lens assembly 78, to reference the measurements taken from projection lens assembly 78. A first reflective element M1, such as a first mirror, may be attached to wafer table 104 to reflect objective and/or reference beams from first sensor 110. Therefore, measurements of distances along the x and y axes (dₓ and d_{y}, respectively) and rotation around the z axis (θ_{z}) between projection lens assembly 78 and wafer table 104 can be determined.

Second sensor 112 is preferably a second plurality of interferometers to determine a position and a rotation of wafer table 104 relative to wafer stage base 102. Second plurality of interferometers 112 may include a fourth interferometer (not shown) to measure a distance of wafer table 104 relative to wafer stage base 102 along the z axis (d_{z}), a fifth interferometer (not shown) to measure a rotation of wafer table 104 relative to wafer stage base 102 around the x axis (θₓ), and a sixth interferometer (not shown) to measure a rotation of wafer table 104 relative wafer stage base 102 around the y axis (θ_{y}).

FIG. 3 illustrates a first embodiment consistent with the principles of the present invention. According to the first embodiment, second sensor 112 may be attached to wafer table 104 and a mirror assembly 130 attached to wafer stage 66. Mirror assembly 130 functions as a reference guide to measure the distance and rotation of wafer table 104 relative to wafer stage base 102. Wafer stage base 102 provides a better referencing surface than wafer stage 66 because wafer stage base 102 is a more steady reference structure than wafer stage 66. Mirror assembly 130 preferably rides on a bearing 128, such as a vacuum-preloaded air bearing, that has a high stiffness to provide a substantially constant vertical distance between mirror assembly 130 and wafer stage base 102. Bearing 128 is separate from air bearing 126 discussed in the Description of Related Art. Since mirror assembly 130 is much lighter than wafer stage 66, bearing 128 provides a substantially constant or known distance between a top surface of wafer stage base 102 and a bottom surface of mirror assembly 130 along the z axis. Thus, mirror assembly 130 will accurately track the vertical position of wafer stage base 102.

Mirror assembly 130 has a padding 132 for supporting a second reflecting element M2, such as a second mirror, to reflect reference and/or objective beams from second sensor 112. Therefore, measurements of distance along the z axis (d_{z}) and rotations around the x and y axes (θₓ and θ_{y}, respectively) between wafer table 104 and wafer stage base 102 can be determined.

Mirror assembly 130 is attached to wafer stage 66 via a flexure 134. Flexure 134 has the characteristics of being flexible in a vertical direction along the z axis to maintain a substantially constant vertical distance (d_{z}) between mirror assembly 130 and wafer stage base 102, and being rigid in a horizontal plane along the x and y axes to allow or follow movement of wafer stage 66.

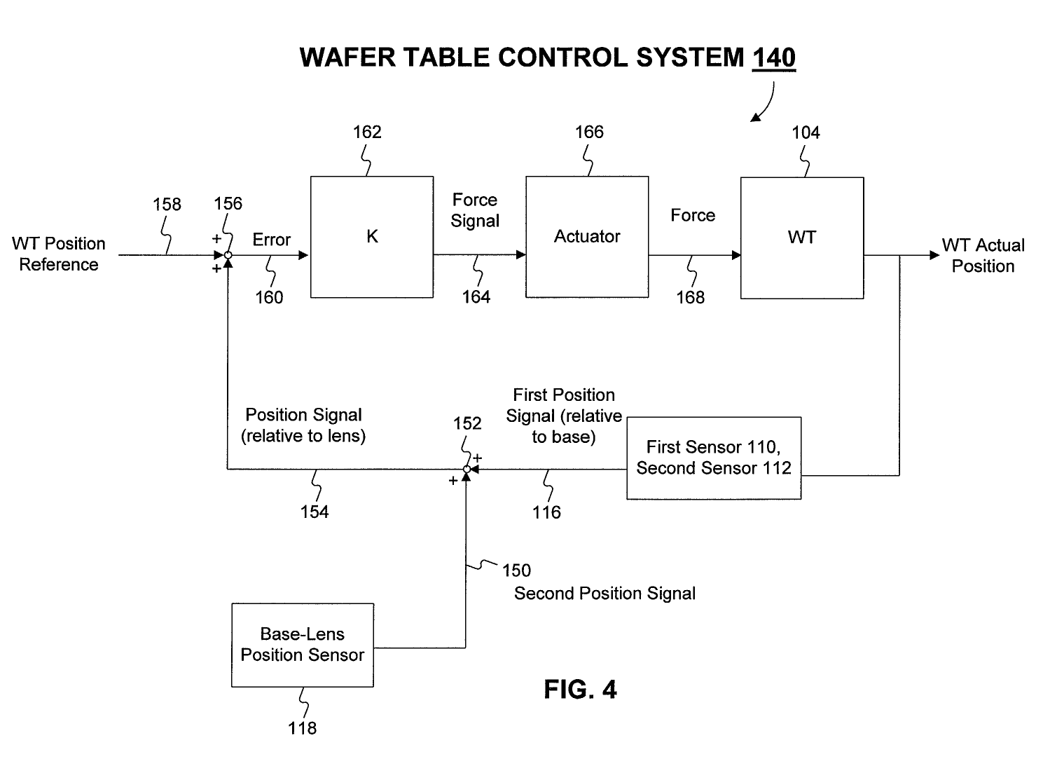

Consistent with the principles of the present invention and as shown in FIG. 4, a wafer table control system 140 is provided to control wafer table 104 based on the actual position and rotation measured by first sensor 110 and second sensor 112. First and second sensors, 110 and 112, respectively, generate a first position signal 116 representing the position and rotation of wafer table 104 relative to wafer stage base 102. A base-to-lens sensor 118 is provided to measure the position of wafer assembly base (i.e. vibration isolation system 122) relative to lens assembly 78, and sends an output of a second position signal 150. First position signal 116 and second position signal 150 are added at a summing junction 152, and resulted in a position signal 154 representing the position and rotation of wafer table 104 relative to lens assembly 78.

In one embodiment, base-to-lens sensor 118 may use a set of three (3) sensors, each for measuring the position of base 122 along the z axis and the rotation of base 122 around the x and y axes. These three sensors may be interferometers, capacitance probes, encoders, or any commercially available sensors. Alternatively, the relative position of lens assembly 78 and base 122 can be calculated from position sensors (not shown) provided in first and second vibration isolation system, 122 and 124, respectively.

Thereafter, at summing junction 156, position signal 154 is compared with a reference position signal 158. Reference position signal 158 is a desired position of wafer table 104 generated by the wafer manufacturing control system (not shown) based on the output of AF/AL sensor 114. Summing junction 156 sends an output position and rotation error signal 160. A controller 162, such lead-lag, PID, or any commercially available controller, determines a force signal 164 based on position and rotation error signal 160. A set of actuators 166 generates a corresponding force 168 acting on wafer table 104 to control the position and rotation of wafer table 104.

The set of actuators 166, although illustrated as a voice-coil motor (VCM), could be any types of commercially available actuators, including an El core actuator. The set of actuators 166 generates a vertical force between wafer stage 66 and wafer table 104. In one embodiment, a set of three (3) actuators 166 may be used to adjust the position of wafer table 104 along the z axis, and the rotation of wafer table 104 around the x and y axes. Alternatively, more or less than 3 actuators 166 may also be used. In addition, additional actuators (not shown) may be provided to produce horizontal forces between wafer stage 66 and wafer table 104 for adjusting the position of wafer table 104 along the x and y axes and the rotation of wafer table 104 around the z axis. Therefore, the principles of the present invention are applicable in a wafer table having any degrees of freedom, including 3 or 6 degrees of freedom.

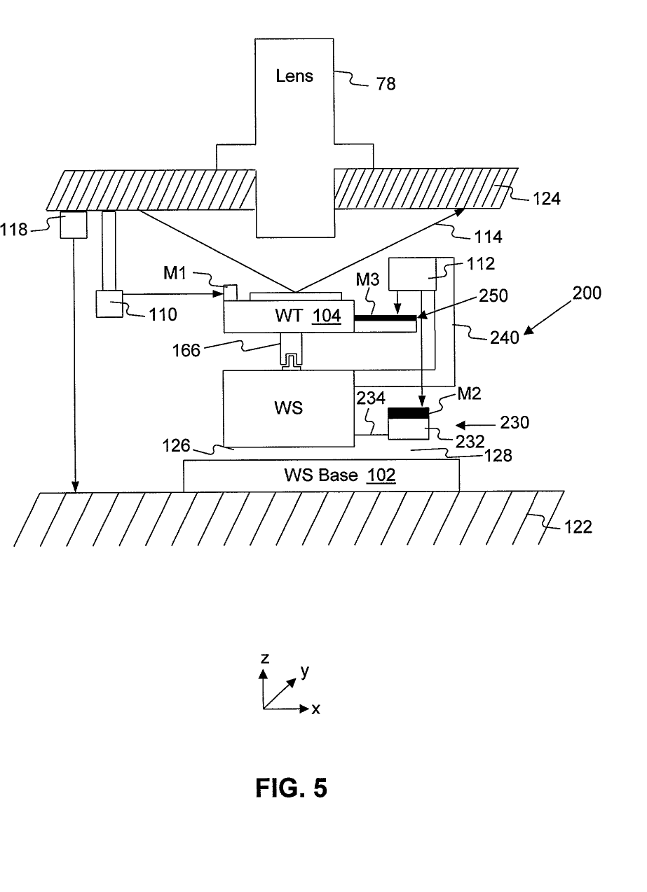

FIG. 5 illustrates a second embodiment of wafer stage assembly 200 consistent with the principles of the present invention. FIG. 5 shows second sensor 112 being attached to wafer stage 66 via an extension arm 240 to reduce the weight of wafer table 104. In practice, an interferometer can be quite heavy to be attached to or supported by wafer table 104. The second embodiment is designed to reduce the weight supported by wafer table 104.

Mirror assembly 230, similar to mirror assembly 130 discussed according to the first embodiment, is also utilized in the second embodiment. Mirror assembly 230 rides on bearing 128 that provides a substantially constant vertical distance between mirror assembly 230 and wafer stage base 102. Mirror assembly 230 includes a padding 232 for supporting the second reflecting element M2, such as the second mirror, to reflect reference and/or objective beams from second sensor 112. Thus, measurements of distance along the z axis (d_{z}) and rotations around the x and y axes (θₓ and θ_{y}, respectively) between wafer table 104 and wafer stage base 102 can be determined. Similarly, mirror assembly 230 is attached to wafer stage 66 via a flexure 234. Flexure 234 has the characteristics of being flexible in a vertical direction along the z axis to maintain a substantially constant vertical distance (d_{z}) between mirror assembly 230 and wafer stage base 102, and being rigid in a horizontal plane along the x and y axes to allow or follow movement of wafer stage 66.

A reference assembly 250, having a third reflective element M3, such as a third mirror, and a structure similar to mirror assembly 230, is rigidly attached to wafer table 104. Reflective element M3 is positioned upward on reference assembly 250 facing towards second sensor 112. Reference assembly 250 functions as another reference guide to measure the distance and rotation of wafer table 104 relative to wafer stage base 102.

Second reflective element M2 reflects reference and/or objective beams from second sensor 112, thereby a distance and a rotation between second sensor 112 and wafer stage 66 can be determined. Since mirror assembly 230 closely follows the movement of wafer stage base 102, the distance and rotation between second sensor 112 and wafer stage base 102 can then be determined. Third reflective element M3 reflects reference and/or objective beams from second sensor 112, thereby a distance and a rotation between second sensor 112 and wafer table 104 can be determined. Combining the results measured between second sensor 112 and second reflective element M2 and between second sensor 112 and third reflective element M3, measurements of distance along the z axis (d_{z}) and rotations around the x and y axes (θₓ and θ_{y}, respectively) between wafer table 104 and wafer stage base 102 can be determined.

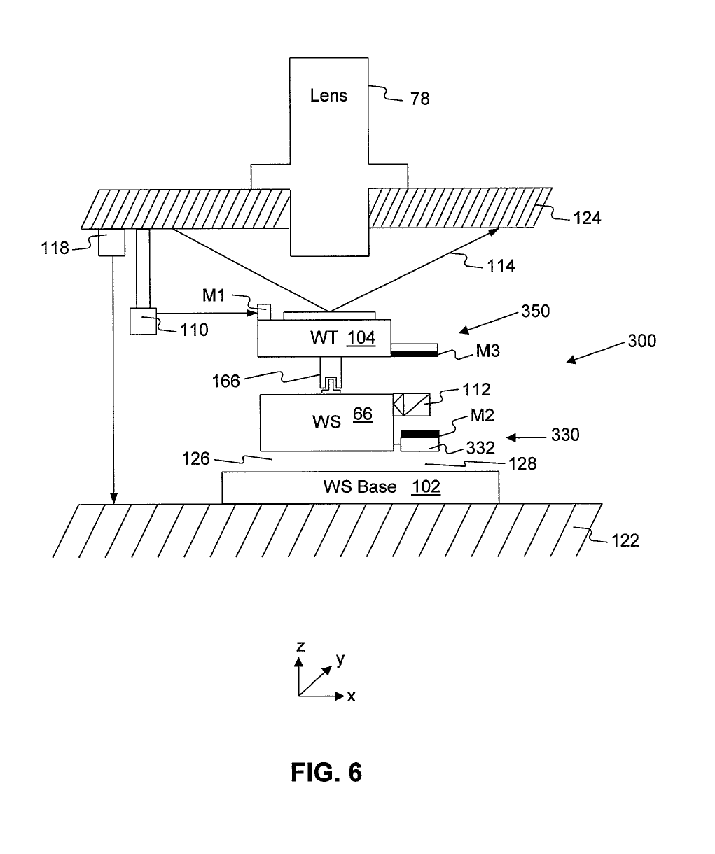

FIG. 6 illustrates a third embodiment of wafer stage assembly 300 consistent with the principles of the present invention. FIG. 6 shows second sensor 112 being attached directly to wafer stage 66 without extension arm 240 of wafer stage assembly 200. Similar to the discussions with respect to the second embodiment, mirror assembly 330, having second reflecting element M2, and reference assembly 350, having third reflecting element M3, are also utilized in the third embodiment. In the third embodiment, reflective element M3 is positioned downward, instead of upward as in the second embodiment, facing towards second sensor 112.

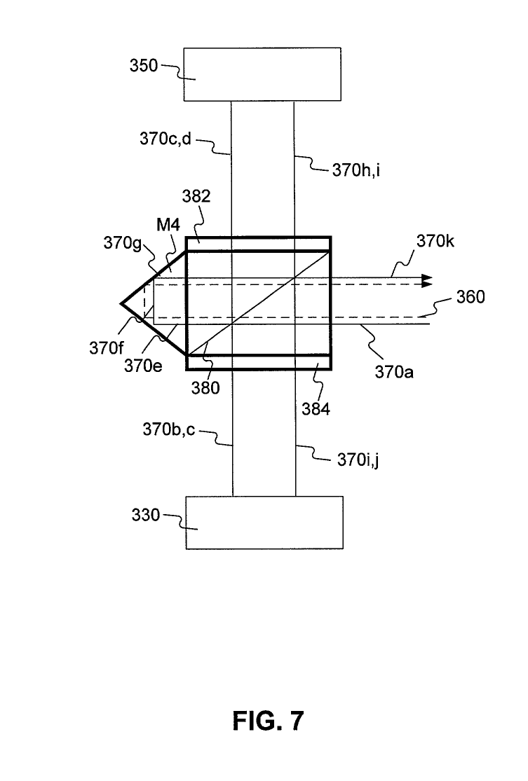

FIG. 7 illustrates second sensor 112 in greater detail. Second sensor 112 is provided with a fourth reflecting element M4 to reflect one or more reference beams 360 coming out of second sensor 112. Fourth reflecting element M4 may be a 90° reference retro-reflector as shown in FIG. 7, or a planar mirror, or any equivalents.

Second sensor 112 is also provided with a polarizing beam splitter 380 and a pair of quarter wavelength (¼-λ) plates 382, 384 to reflect one or more objective beams 370 coming out of second sensor 112. Beam splitter 380 will allow incoming beam having a non-reflective polarization to pass through it, but will reflect incoming beam having a reflective polarization. For example, reference beam 360, shown in dashed lines, has a non-reflective polarization, while objective beam 370a, shown in solid lines, has a reflective polarization.

In operation, reference beam 360 coming from second sensor 112 having a non-reflective polarization will pass through beam splitter 380, be reflected by fourth reflecting element M4, pass through beam splitter 380 again, and return to second sensor 112.

Objective beam 370a having a reflective polarization will be reflected by beam splitter 380 toward lower ¼-λ plate 384 as beam 370b, reflected by second reflective element M2 on mirror assembly 330 as beam 370c, and back toward lower ¼-λ plate 384. By this time, objective beam 370c has passed through lower ¼-λ plate 384 twice, therefore, objective beam 370c has experienced a first ½-λ transition, i.e. changing polarization from a reflective polarization to a non-reflective polarization.

Objective beam 370c, having a non-reflective polarization, passes through beam splitter 380 and upper ¼-λ plate 382. Objective beam 370c is then reflected by third reflective element M3 on reference assembly 350 as beam 370d through upper ¼-λ plate 382. This time, objective beam 370d has passed through upper ¼-λ plate 382 twice, resulting in a second ½-λ transition, i.e. changing polarization from a non-reflective polarization back to a reflective polarization.

Objective beam 370d, having a reflective polarization, is then reflected by beam splitter 380 toward fourth reflective element M4 (beam 370e, 370f, and 370g), reflected by beam splitter 380, passing through upper ¼-λ plate 382 as beam 370h, reflected by third reflective element M3 and back toward upper ¼-λ plate 382 as beam 370i. Now, objective beam 370i has passed through upper ¼-λ plate 382 twice, resulting in a third ½-λ transition, i.e. changing polarization from a reflective polarization to a non-reflective polarization.

Objective beam 370i, having a non-reflective polarization, passes through beam splitter 380 and lower ¼-λ plate 384. Objective beam 370i is then reflected by second reflective element M2 on mirror assembly 330 as beam 370j. Then, objective beam 370j has passed through lower ¼-λ plate 384 twice, resulting in a fourth ½-λ transition, i.e. changing polarization from a non-reflective polarization back to a reflective polarization.

Objective beam 370j, having a reflective polarization, is finally reflected by beam splitter 380 out toward second sensor 112 as beam 370k. The structural dimensions of beam splitter 380 and fourth reflective element M4 are fixed and predetermined. Knowing these fixed dimensions and comparing the distances traveled by reference beam 360 and objective beam 370a-k, a distance between wafer table 104 and wafer stage base 102 can be determined.

An alternative to the first, second, and third embodiments, a first plurality of interferometers 110 may include the fifth and sixth interferometers to measure rotations of wafer table 104 relative to projection lens assembly 78 around the x and y axes (θ′ₓ and θ′_{y}, respectively). According to this embodiment, measurements of distances along the x and y axes (dₓ and d_{y}, respectively) and rotations around the x, y, and z axes (θ′ₓ, θ′_{y}, and θ_{z}, respectively) between projection lens assembly 78 and wafer table 104 can be determined.

Wafer table control system 140 discussed with respect to the first embodiment of the present invention may also be used for the second and third embodiments.

In all embodiments, reference and objective beams may be a laser beam transmitted to second sensor 112 by a fiber optic cable or through air.

Also in all embodiments, wafer stage base 102 may be provided with a reflecting surface to reflect reference and objective beams from first sensor 110 to measure directly the positions and rotations of wafer stage base 102 relative to projection lens assembly 78 in all six degrees of freedom. In this case, a mirror assembly is not required, and wafer stage base 102 acts as the second reflective element M2.

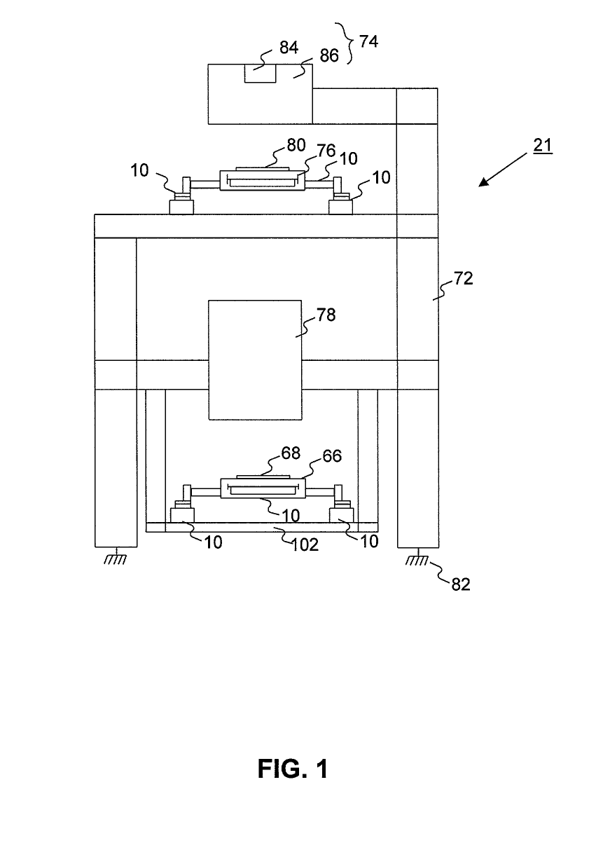

Depending upon the design of exposure apparatus 21, either for a unibody or multi-body photolithography device, apparatus 21 can also include additional servo drive units, linear motors and planar motors 10 (shown in FIG. 1) to move wafer stage 66 and reticle stage 76. The use of exposure apparatus 21 provided herein is not limited to a photolithography system for a semiconductor manufacturing. Exposure apparatus 21, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, inspection machines and disk drives.

The illumination source 84 can be g-line (436 nm), i-line (365 nm), KrF excimer laser (248 nm), ArF excimer laser (193 nm) and F₂ laser (157 nm). Alternatively, illumination source 84 can also use charged particle beams such as x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to lens assembly 78, when far ultra-violet rays such as the excimer laser is used, glass materials such as quartz and fluorite that transmit far ultra-violet rays is preferably used. When the F₂ type laser or x-ray is used, lens assembly 78 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No, 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as wall as Japan Patent Application Disclosure No.10-3039 and its counterpart U.S. patent application Ser. No. 873,606 (Application Date: Jun. 12, 1997) also use a reflecting-refracting type of optical system incorporating a concave mirror, etc., but without a beam splitter, and can also be employed with this invention. The disclosures in the abovementioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and purity are controlled.

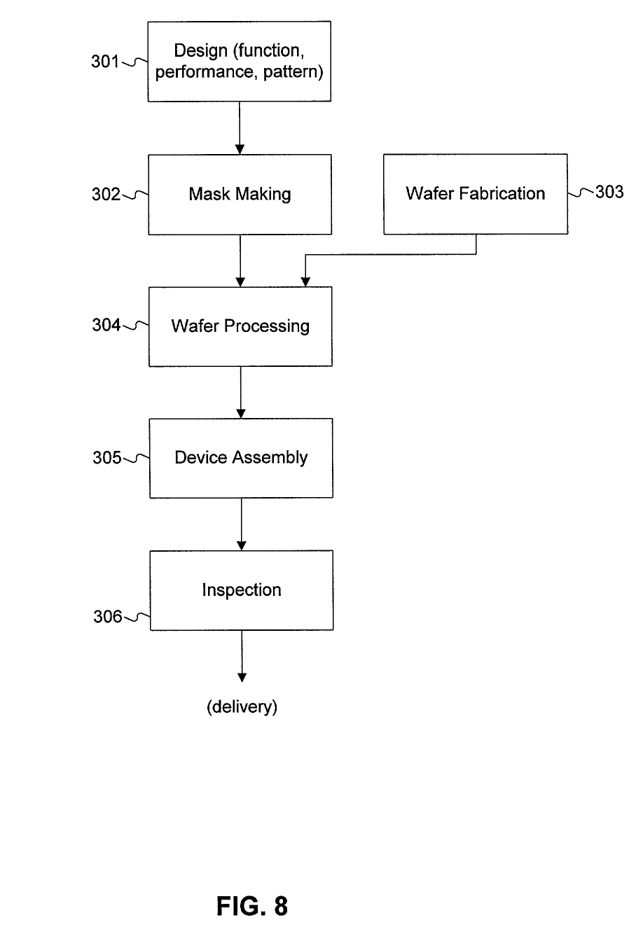

Further, semiconductor devices can be fabricated using the above described systems, by the process shown generally in FIG. 8. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 306 the semiconductor device is assembled (including the dicing process, bonding process and packaging process), then finally the device is inspected in step 306.

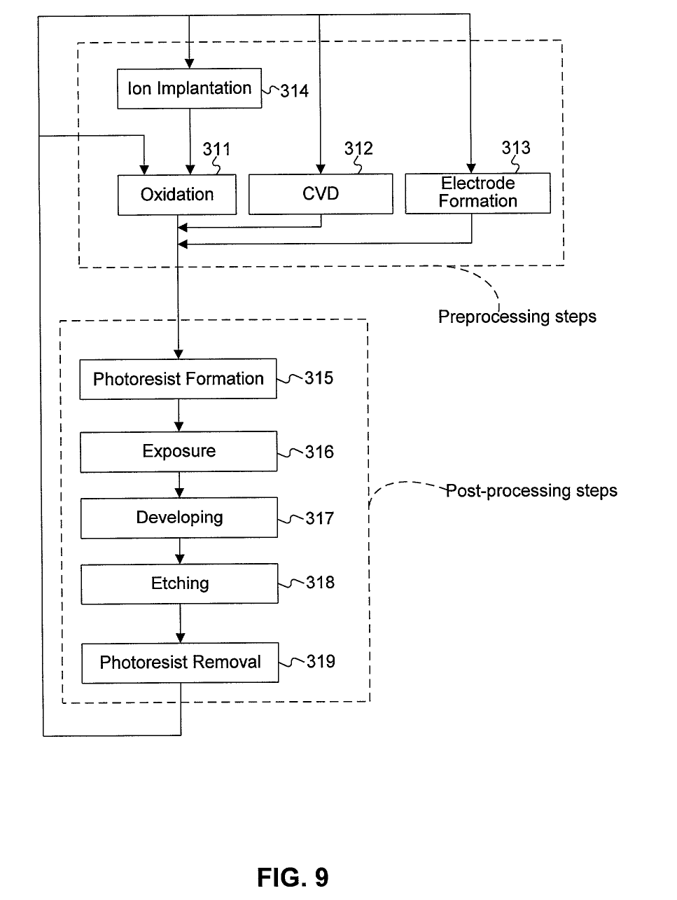

FIG. 9 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted In the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed.

Multiple circuit patterns are formed by repetition of these preprocessing and post-processing steps.

It will be apparent to those skilled in the art that various modifications and variations can be made in the methods described, in the stage device, the control system, the material chosen for the present invention, and in construction of the photolithography systems as well as other aspects of the invention without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

We claim:

1. A wafer stage assembly for use in combination with a projection lens assembly in a semiconductor wafer manufacturing process, comprising:
a wafer table supported and positioned by a wafer stage and a wafer stage base for carrying at least one semiconductor wafer; and
at least one sensor system that determines position and rotation of the wafer table in six degrees of freedom relative to the projection lens assembly, at least a part of the sensor system being connected to the wafer table.

2. The wafer stage assembly of claim 1, wherein the at least one sensor system comprises:
a first sensor system to determine position and rotation of the wafer table relative to the projection lens assembly in at least one of the six degrees of freedom; and
a second sensor system to determine position and rotation of the wafer table relative to the wafer stage base in the remaining of the six degrees of freedom.

3. The wafer stage assembly of claim 2, wherein the first sensor system comprises:
a first plurality of interferometers attached to the projection lens assembly.

4. The wafer stage assembly of claim 3, wherein the first sensor system further comprises:
a first reflective element attached to one of the wafer table and a reflecting surface of the wafer stage base.

5. The wafer stage assembly of claim 3, wherein the first plurality of interferometers comprise:
a first interferometer to measure a distance of the wafer table relative the projection lens assembly along an x axis;
a second interferometer to measure a distance of the wafer table relative the projection lens assembly along a y axis; and
a third interferometer to measure a rotation of the wafer table relative the projection lens assembly around a z axis,
wherein the z axis is substantially parallel to an axis of the projection lens assembly, and the x and y axes are orthogonal to each other and to the z axis.

6. The wafer stage assembly of claim 2, wherein the second sensor system comprises:
a second plurality of interferometers; and
a second reflective element facing toward the second plurality of interferometers.

7. The wafer stage assembly of claim 6, wherein the second plurality of interferometers comprise:
a fourth interferometer to measure a distance of the wafer table relative the wafer stage base along a z axis;
a fifth interferometer to measure a rotation of the wafer table relative the projection lens assembly around an x axis; and
a sixth interferometer to measure a rotation of the wafer table relative the projection lens assembly around a y axis,
wherein the z axis is substantially parallel to an axis of the projection lens assembly, and the x and y axes are orthogonal to each other and to the z axis.

8. The wafer stage assembly of claim 6, wherein the second sensor system further comprises:
a mirror assembly attached to the wafer stage, the mirror assembly supporting the second reflective element.

9. The wafer stage assembly of claim 8, further comprising:
a connecting member disposed between the wafer stage and the mirror assembly, the connecting member having a flexibility along a vertical direction being parallel with an axis of the projection lens assembly, and rigidity in a horizontal plane normal to the vertical direction.

10. The wafer stage assembly of claim 6, wherein the second reflective element is the wafer stage base.

11. The wafer stage assembly of claim 8 wherein the mirror assembly has the characteristics of:
flexibly attached to the wafer stage in a vertical direction to maintain a substantially constant vertical distance between the mirror assembly and the wafer stage base, the vertical direction being parallel with an axis of the projection lens assembly; and
rigidly attached to the wafer stage in a horizontal plane normal to the vertical direction to allow movement of the wafer stage.

12. The wafer stage assembly of claim 6, wherein the second plurality of interferometers are attached to the wafer table.

13. The wafer stage assembly of claim 6, wherein the second plurality of interferometers are attached to the wafer stage.

14. The wafer stage assembly of claim 13, wherein the second sensor system further comprises:
a reference assembly attached to the wafer table, the reference assembly having a third reflective element positioned on a horizontal plane substantially normal to the vertical direction facing toward the second plurality of interferometers.

15. The wafer stage assembly of claim 14, wherein the second plurality of interferometers comprise:
polarizing beam splitter having a pair of quarter wavelength plates to reflect an objective beam having a non-reflective polarization; and
a fourth reflecting element to reflect a reference beam having a reflective polarization.

16. The wafer stage assembly of claim 1, further comprising:
a first bearing of pressurized fluid separating the mirror assembly from the wafer stage base and providing a substantially constant vertical distance between the mirror assembly and the wafer stage base.

17. The wafer stage assembly of claim 16, further comprising:
a second bearing of pressurized fluid separating the wafer stage from the wafer stage base.

18. The wafer stage assembly of claim 2, wherein the at least one sensor system further comprises:
a third sensor system to determine position and rotation of a surface of the wafer table relative to the projection lens assembly.

19. The wafer stage assembly of claim 18, wherein the third sensor system is an auto-focus and auto-leveling sensor.

20. An object on which an image has been formed by the wafer stage assembly of claim 1.

21. A lithography system comprising a wafer stage assembly of claim 1.

22. An exposure apparatus to form a pattern on a wafer by utilizing a projection lens assembly, comprising:
a wafer stage assembly having a wafer table that carries the wafer, and a wafer stage that positions the wafer table on a wafer stage base;
a first sensor system that detects at least one of position and rotation of the wafer table relative to the projection lens assembly; and
a second sensor system that detects at least one of position and rotation of the wafer table relative to the stage base.

23. The exposure apparatus of claim 22, wherein the first sensor system comprises:
a first plurality of interferometers attached to the projection lens assembly and a first reflective element attached to any one of the wafer table and a reflecting surface of the wafer stage base.

24. The exposure apparatus of claim 22, wherein the second sensor system comprises:
a second plurality of interferometers; and
a second reflective element facing toward the second plurality of interferometers.

25. The exposure apparatus of claim 24, wherein the second sensor system further comprises:
a mirror assembly attached to the wafer stage, the mirror assembly supporting the second reflective element.

26. The wafer stage assembly of claim 25, further comprising:
a connecting member disposed between the wafer stage and the mirror assembly, the connecting member having a flexibility along a vertical direction being parallel with an axis of the projection lens assembly, and rigidity in a horizontal plane normal to the vertical direction.

27. The exposure apparatus of claim 24, wherein the second reflective element is the wafer stage base.

28. The exposure apparatus of claim 25, wherein the mirror assembly has the characteristics of being:
flexibly attached to the wafer stage in a vertical direction to maintain a substantially constant vertical distance bet ween the mirror assembly and the wafer stage base, the vertical direction being parallel with an axis of the projection lens assembly; and
rigidly attached to the wafer stage in a plane normal to the vertical direction to allow movement of the wafer stage.

29. The exposure apparatus of claim 24, wherein the second plurality of interferometers are attached to the wafer table.

30. The exposure apparatus of claim 24, wherein the second plurality of interferometers are attached to the wafer stage.

31. The exposure apparatus of claim 3G, wherein the second sensor system further comprises:
a reference assembly attached to the wafer table, the reference assembly having a third reflective element positioned on a horizontal plane normal to the vertical direction facing toward the second plurality of interferometers.

32. The exposure apparatus of claim 30, wherein the second plurality of interferometers comprise:
a polarizing beam splitter having a pair of quarter wavelength plates to reflect an objective beam having a non-reflective polarization; and
a fourth reflecting element to reflect a reference beam having a reflective polarization.

33. The exposure apparatus of claim 22, further comprising:
a first bearing of pressurized fluid separating the mirror assembly from the wafer stage base and providing a substantially constant vertical distance between the mirror assembly and the wafer stage base.

34. The exposure apparatus of claim 33, further comprising:
a second bearing of pressurized fluid separating the wafer stage from the wafer stage base.

35. The exposure apparatus of claim 22, wherein the at least one sensor system further comprises:
a third sensor system to determine position and rotation of a surface of the wafer table relative to the projection lens assembly.

36. The exposure apparatus of claim 35, wherein the third sensor system is an auto-focus and auto-leveling sensor.

37. The exposure apparatus of claim 22, wherein the projection lens assembly is supported by a first vibration isolation system, and the wafer stage assembly is supported by a second vibration isolation system.

38. An object on which an image has been formed by the exposure apparatus of claim 22.

39. A lithography system comprising the exposure apparatus of claim 22.

40. A method for making a wafer stage assembly for use in combination with a projection lens assembly in a semiconductor wafer manufacturing process, comprising the steps of:
providing a wafer table supported and positioned by a wafer stage and a wafer stage base for carrying a semiconductor wafer;
connecting a part of a first sensor system to the wafer table so that the first sensor system determines position and rotation of the wafer table relative to the projection lens assembly; and
connecting a part of a second sensor system to the wafer table so that the second sensor system determines position and rotation of the wafer table relative to the wafer stage base.

41. The method of claim 40, wherein the step of connecting a part of a first sensor system comprises:
connecting a first plurality of interferometers to the projection lens assembly.

42. The method of claim 41, wherein the step of connecting a part of a first sensor system further comprises:
connecting a first reflective element to one of the wafer table and a reflecting surface of the wafer stage base.

43. The method of claim 40, wherein the step of connecting a part of a second sensor system comprises:
providing a second plurality of interferometers; and
disposing a second reflective element so that the second reflective element faces toward the second plurality of interferometers.

44. The method of claim 43, wherein the second reflective element is the wafer stage base.

45. The method of claim 43, wherein the step of connecting a part of a second sensor system further comprises:
attaching a mirror assembly to the wafer stage, the mirror assembly supporting the second reflective element.

46. The method of claim 45 wherein the step of attaching a mirror assembly comprises:
flexibly attaching the mirror assembly to the wafer stage in a vertical direction to maintain a substantially constant vertical distance between the mirror assembly and the wafer stage base, the vertical direction being parallel with an axis of the projection lens assembly; and
rigidly attaching the mirror assembly to the wafer stage in a horizontal plane normal to the vertical direction to allow movement of the wafer stage.

47. The method of claim 43, wherein the step of providing a second plurality of interferometers comprises:
attaching the second plurality of interferometers to the wafer table.

48. The method of claim 43, wherein the step of providing a second plurality of interferometers comprises:
attaching the second plurality of interferometers to the wafer stage.

49. The method of claim 48, wherein the step of providing a second plurality of interferometers further comprises:
attaching a reference assembly to the wafer table, the reference assembly having a third reflective element positioned on a horizontal plane normal to the vertical direction facing toward the second plurality of interferometers.

50. The method of claim 49, wherein the step of providing a second plurality of interferometers further comprises:
providing a polarizing beam splitter having a pair of quarter wavelength plates to reflect an objective beam having a non-reflective polarization; and providing a fourth reflecting element to reflect a reference beam having a reflective polarization.

51. The method of claim 40, further comprising:
disposing a first bearing between the mirror assembly and the wafer stage base so that pressurized fluid of the first bearing separates the wafer stage from the wafer stage base and provides a substantially constant vertical distance between the mirror assembly and the wafer stage base.

52. The method of claim 51, further comprising:
disposing a second bearing between the wafer stage and the wafer stage base so that pressurized fluid of the second bearing separates the wafer stage from the wafer stage base.

53. The method of claim 41, further comprising:
providing a third sensor system to determine a position and a rotation of a surface of the wafer table relative to the projection lens assembly.

54. The method of claim 53, wherein the third sensor system is an auto-focus and auto-leveling sensor.

55. A method for making a lithography system comprising the wafer stage assembly that is made by utilizing the method of claim 40.

56. A method for making an object on which an image has formed by the lithography system that is made by utilizing the method of claim 55.

57. A method for determining a position of a semiconductor wafer table in a semiconductor wafer manufacturing process, comprising the steps of:
supporting and positioning a semiconductor wafer on a wafer stage assembly relative to a projection lens system, the wafer stage assembly having a wafer table, a wafer stage, and a wafer stage base; and
measuring position and rotation of the wafer table in six degrees of freedom relative to the projection lens assembly.

58. The method of claim 57, wherein the measuring step further comprises:
measuring position and rotation of the wafer table relative to the projection lens assembly in at least one of the six degrees of freedom; and
measuring position and rotation of the wafer table relative to a wafer stage base in the remaining of the six degrees of freedom.

59. The method of claim 58, wherein position and rotation of the wafer table relative to the projection lens assembly are measured by a first plurality of interferometers.

60. The method of claim 59, wherein the step of measuring position and rotation of the wafer table relative to the projection lens assembly utilizes a first reflective element attached to one of the wafer table and a reflecting surface of the wafer stage base.

61. The method of claim 58, wherein position and rotation of the wafer table relative to wafer stage base are measured by a second plurality of interferometers and a second reflective element facing toward the second plurality of interferometers.

62. The method of claim 61, wherein the second reflective element is the wafer stage base.

63. The method of claim 61, wherein the step of measuring position and rotation of the wafer table relative to a wafer stage base utilizes a mirror assembly that is attached to the wafer stage and supports the second reflective element.

64. The method of claim 63, wherein:
the mirror assembly is flexibly connected to the wafer stage in a vertical direction to maintain a substantially constant vertical distance between the mirror assembly and the wafer stage base;
the mirror assembly is rigidly connected to the wafer stage in a horizontal plane normal to the vertical direction to allow movement of the wafer stage; and
the vertical direction being parallel substantially to an axis of the projection lens assembly.

65. The method of claim 61, wherein the second plurality of interferometers are attached to the wafer stage.

66. The method of claim 61, wherein the second plurality of interferometers are attached to the wafer stage.

67. The method of claim 66, wherein the step of measuring position and rotation of the wafer table relative to a wafer stage base utilizes a reference assembly that is attached to the wafer table and supports a third reflective element positioned on a horizontal plane normal to the vertical direction facing toward the second plurality of interferometers.

68. The method of claim 67, wherein the step of providing a second plurality of interferometers further comprises:
reflecting an objective beam having a non-reflective polarization off of a polarizing beam splitter having a pair of quarter wavelength plates; and
reflecting a reference beam having a reflective polarization off of a fourth reflecting element.

69. The method of claim 57, further comprising:
setting a vertical distance between the mirror assembly and the wafer stage base substantially constant by providing a first layer of pressurized fluid separating the mirror assembly from the wafer stage base.

70. The method of claim 69, further comprising:
providing a second layer of pressurized fluid separating the wafer stage from the wafer stage base.

71. The method of claim 58, wherein position and rotation of the wafer table relative to the projection lens assembly are measured by a third sensor system.

72. The method of claim 71, wherein the third sensor system is an auto-focus and auto-leveling sensor.

73. A method for operating a lithography system including a semiconductor wafer table and utilized in a wafer manufacturing process comprising:
determining the position of the semiconductor wafer table by utilizing the method of claim 57.

74. A method for making an object on which an image has formed by the lithography system utilizing the method of claim 73.

75. A method for determining a position on a surface of a semiconductor wafer relative to a projection lens system, the wafer being supported by a wafer table and positioned by a wafer stage and a wafer stage base, comprising the steps of:
determining position and rotation of the wafer table relative to a projection lens system; and
determining position and rotation of the wafer table relative to the wafer stage base.

76. The method of claim 75, further comprising a step of:
determining position and rotation of a surface of the wafer table relative to the projection lens system.

77. The wafer stage assembly of claim 2, wherein the at least one sensor system further comprises:
a fourth sensor system that determines position and rotation of the wafer stage base relative to the projection lens assembly.

78. The wafer stage assembly of claim 22, wherein the at least one sensor system further comprises:
a fourth sensor system that determines position and rotation of the wafer stage base relative to the projection lens assembly.

79. The method of claim 41, further comprising:
providing a fourth sensor system to determine position and rotation of the wafer stage base relative to the projection lens assembly.

80. The method of claim 57, wherein the measuring step further comprises, measuring position and rotation of the wafer stage base relative to the projection lens assembly.
